(19) United States
(12) Patent Application Publication
(10) Pub. No.: US 2011/0090272 A1
(43) Pub. Date: Apr. 21, 2011

(54) LIQUID EJECTING APPARATUS AND METHOD OF CONTROLLING LIQUID EJECTING APPARATUS

(75) Inventor: Hiroyuki MATSUO, Shiojiri-shi (JP)

(73) Assignee: SEIKO EPSON CORPORATION, Tokyo (JP)

(21) Appl. No.: 12/892,006

(22) Filed: Sep. 28, 2010

(30) Foreign Application Priority Data
Oct. 20, 2009 (JP) 2009-241121

(51) Int. Cl. B41J 29/38

(52) U.S. Cl. 347/10

(57) ABSTRACT

The ejection driving pulse is a voltage waveform including: a first variation section; a hold section; and a second variation section. The second variation section includes: a first variation; an intermediate hold component; and a second variation component. The hold time of the intermediate hold component is greater than 0 and 0.12 Tc or less. The potential of the intermediate hold component is in the range from 50% to 60% of the potential of the hold section.

The entire disclosure of Japanese Patent Application No: 2009-241121, filed Oct. 20, 2009 are expressly incorporated by reference herein.

### BACKGROUND

1. Technical Field

The present invention relates to a liquid ejecting apparatus such as an ink jet printer and a method of controlling the liquid ejecting apparatus, and more particularly, to a liquid ejecting apparatus capable of controlling ejection of a liquid by applying an ejection driving pulse to a pressure generation unit and a method of controlling the liquid ejecting apparatus.

2. Related Art

A liquid ejecting apparatus is an apparatus which includes a liquid ejecting head having nozzles ejecting a liquid and ejects various kinds of liquids from the liquid ejecting head. A representative example of the liquid ejecting apparatus is an image printing apparatus such as a ink jet printer (hereinafter, simply referred to as a printer) which includes an ink jet print head (hereinafter, simply referred to as a print head) as a liquid ejecting head and prints an image or the like by ejecting and landing liquid-like ink from nozzles of the print head on a print medium (landing target) to form dots. In recent years, the liquid ejecting apparatus has been applied not only to the image printing apparatus, but also various manufacturing apparatuses such as an apparatus manufacturing a color filter such as a liquid crystal display.

For example, a printer includes a nozzle row (nozzle group) in which a plurality of nozzles are arranged. In the printer, an ejection driving pulse is applied to a pressure generation unit (for example, a piezoelectric vibrator or a heating device) to drive the pressure generation unit, and a pressure variation is applied to a liquid in a pressure chamber to eject the liquid from the nozzles communicating with the pressure chamber. In such a known printer, when the ink is simultaneously ejected from the plurality of nozzles adjacent to each other in the nozzle row, the adjacent nozzles may affect each other due to vibrations or the like caused by the pressure variation or the driving of the pressure generation unit. Then, when the ink is ejected from one nozzle and when the ink is ejected simultaneously from the plurality of adjacent nozzles, a problem may arise in that so-called cross talk occurs in a case where ejection characteristics such as the flying speed and amount (mass or volume) of the ejected ink are changed. In particular, the nozzles generally have a tendency to be designed at higher density to meet the need for improving the quality of a printed image. When the nozzles are arranged at higher density, the cross talk easily occurs upon simultaneously ejecting the ink from the adjacent nozzles.

FIGS. 7A and 7B are diagrams for explaining the cross talk when ink is ejected by a known printer. More specifically, FIGS. 7A and 7B are the diagrams illustrating a case where the ink is ejected toward a print medium from the respective nozzles of a nozzle row, when viewed from a direction (transverse direction) intersecting the flying direction of the ink. In the drawings, an upper straight line indicates a nozzle surface of the print head and a lower straight line indicates a print surface of the print medium. The nozzles of #1 to #36 are illustrated among all of the nozzles (for example, the nozzles from #1 to #180) of the nozzle row. FIG. 7A shows a case where the ink is ejected from six adjacent nozzles at an interval between three nozzles. That is, FIG. 7A shows the case (6 ON and 3 OFF) where the ink is ejected from the nozzles of #1 to #6, #10 to #15, #19 to #24, and #28 to #33 among the nozzles of #1 to #36 in the drawing, and the ink is not ejected from the nozzles of #7 to #9, #16 to #18, #25 to #27, and #34 to #36. FIG. 7B shows a case where the ink is ejected from all of the nozzles (the nozzles of #1 to #36 in the drawing) of #1 to #180. In the drawings, an ink droplet ejected from one nozzle is formed by a preceding main liquid droplet and a subsequent satellite liquid droplet separated from the main liquid droplet.

When the ink is ejected simultaneously from the plurality of adjacent nozzles, the adjacent nozzles affect each other due to the vibrations or the like occurring in the ejection time. Then, the flying speed of the ink is reduced by the nozzles located in the middle of the adjacent nozzle groups, and thus the flying speed of the ink has a tendency to increase by the nozzles located in the ends of the adjacent nozzle groups. For this reason, when the ink ejected from the nozzle groups is observed, the respective ink flies in nearly arch form. Here, the ink flying at high flying speed is landed on the print medium in a short time.

The time that the ink is landed on the print medium lengthens as the flying speed slows. In addition, in a configuration in which printing is executed while the print head is moved relative to the print medium, the landing positions of the respective ink droplets on the print medium are different from each other depending on the flying speeds of the ink droplets. For this reason, when dot groups formed by the landing of the respective ink droplets on the print medium are observed in a plan view, the dot groups are arranged in a curved arch form. Therefore, a problem may arise in that the quality of the printed image deteriorates.

In order to resolve these problems, for example, a configuration is disclosed in which the interval between the adjacent nozzles is set to be larger (for example, twice) than a formation pitch corresponding to a print resolution, a plurality of nozzle rows ejecting the same ink are arranged in a plurality of lines and the ink is ejected from the nozzles of each nozzle row at a time delay (see JP-A-2009-012339). JP-A-2009-012339 discloses the configuration in which a group A is organized by every other nozzles among first cyan nozzles NC1 of a first cyan nozzle row C1 and second cyan nozzles NC2 not pairing with the earlier selected first cyan nozzles NC1 among second cyan nozzles NC2 of a second cyan nozzle row C2, a group B is organized by the first cyan nozzles NC1 and the second cyan nozzles NC2 not belonging to the group A, and the both groups are changed by every predetermined time to be set as a using target group, the ink is ejected from the nozzles belonging to the set using target group to form dot rows on the print medium, and then an operation of moving the print medium relative to the print head is repeated. That is, the cross talk is prevented by setting the interval between the nozzles to be large.

In the configuration disclosed in JP-A-2009-012339, however, problems may arise the size of the print head is increased to the extent that the nozzle rows ejecting the same kind (the same color) of ink are arranged in a plurality of lines and the ejection control of the ink becomes complicated.

### SUMMARY

An advantage of some aspects of the invention is that it provides a liquid ejecting apparatus capable of preventing cross talk even when a liquid is ejected simultaneously from a plurality of nozzles adjacent to each other in the same nozzle group without changing the configuration or size of a liquid ejecting head, and a method of controlling the liquid ejecting apparatus.

According to an aspect of the invention, there is provided a liquid ejecting apparatus including: a liquid ejecting head which includes a nozzle ejecting a liquid, a pressure chamber communicating with the nozzle, and a pressure generation unit applying pressure variation to the liquid of the pressure chamber and which ejects the liquid from the nozzle by an operation of the pressure generation unit; a driving signal generation unit which generates a driving signal containing an ejection driving pulse used to eject the liquid from the nozzle by driving the pressure generation unit; and a movement unit which moves the liquid ejecting head relative to a landing target. A liquid droplet is ejected from the nozzle and is landed on the landing target, while the movement unit moves the liquid ejecting head relative to the landing target. The ejection driving pulse is a voltage waveform including: a first variation section in which a potential is varied in a first direction to vary a volume of the pressure chamber; a hold section in which the volume of the pressure chamber varied by the first variation section holds for a given time and a termination potential of the first variation section is constant; and a second variation section in which the potential is varied in a second direction opposite to the first direction to vary the volume of the pressure chamber varied by the first variation section. The second variation section includes: a first variation component in which the potential is varied in the second direction from the termination potential of the first variation section; an intermediate hold component in which the termination potential of the first variation component holds for a given time; and a second variation component in which the potential is varied in the second direction from the termination potential of the first variation component. The hold time of the intermediate hold component is greater than 0 and 0.12 Tc or less. The potential of the intermediate hold component is in the range from 50% to 60% of the potential of the hold section.

According to another aspect of the invention, there is provided a method of controlling a liquid ejecting apparatus including a liquid ejecting head which includes a nozzle ejecting a liquid, a pressure chamber communicating with the nozzle, and a pressure generation unit applying pressure variation to the liquid of the pressure chamber and which ejects the liquid from the nozzle by an operation of the pressure generation unit, a driving signal generation unit which generates a driving signal containing an ejection driving pulse used to eject the liquid from the nozzle by driving the pressure generation unit, and a movement unit which moves the liquid ejecting head relative to a landing target, the liquid ejecting apparatus ejecting a liquid droplet from the nozzle and landing the liquid droplet on the landing target, while the movement unit moves the liquid ejecting head relative to the landing target. The ejection driving pulse is a voltage waveform including a first variation section in which a potential is varied in a first direction, a hold section in which a termination potential of the first variation section is constant, and a second variation section in which the potential is varied in a second direction opposite to the first direction. The second variation section includes a first variation component in which the potential is varied in the second direction from the termination potential to a halfway potential of the first variation section, an intermediate hold component in which the termination potential of the first variation component holds for a given time, and a second variation component in which the potential is varied in the second direction from the termination potential of the first variation component. The potential of the intermediate hold component is in the range from 50% to 60% of the potential of the hold section. The hold time of the intermediate hold component is greater than 0 and 0.12 Tc or less. The method includes: a first variation step of varying the volume of the pressure chamber by the first variation section; a hold step of holding the volume of the pressure chamber varied in the first variation step for a predetermined time by the hold section; a second variation step of varying the volume of the pressure chamber varied in the first variation step by the second variation section. The second variation step includes: a first variation action of varying the volume of the pressure chamber varied in the first variation step to a halfway volume by the first variation component; a hold action of holding the volume of the pressure chamber varied by the first variation action for a given time; and a second variation action of varying the volume of the pressure chamber holding by the hold action by the second variation component. The hold time in the hold action is greater than 0 and 0.12 Tc or less.

According to the aspects of the invention, the second variation section of the ejection driving pulse includes the first variation component in which the potential is varied in the second direction from the termination potential of the first variation section, the intermediate hold component in which the termination potential of the first variation component holds for the given time, and the second variation component in which the potential is varied in the second direction from the termination potential of the first variation component. The hold time of the intermediate hold component is greater than 0 and 0.12 Tc or less. The potential of the intermediate hold component is in the range from 50% to 60% of the potential of the hold section. By stopping the variation in the volume of the pressure chamber in a very short time while the volume of the pressure chamber is varied, a sudden variation in the pressure of the pressure chamber is suppressed compared to a case where the volume of the pressure chamber is varied at once without stop in a halfway volume. Therefore, when the liquid is simultaneously ejected from the plurality of nozzles adjacent to each other in the nozzle row, cross talk occurring between the adjacent nozzles is reduced. As a consequence, the difference between the flying speeds of the ink droplets ejected from the nozzles is reduced, and thus the difference between landing positions of the ink droplets on the ejecting target is prevented. Moreover, since these advantages can be achieved just by modifying the structure of the ejection driving pulse, the cross talk can be reduced simply without changing the configuration or size of the liquid ejecting head or complicated control.

### BRIEF DESCRIPTION OF THE DRAWINGS

The invention will be described with reference to the accompanying drawings, wherein like numbers reference like elements.

FIG. 1 is a perspective view illustrating the overall configuration of a printer.

FIG. 2 is a sectional view illustrating the configuration of the main units of a print head.

FIG. 3 is a block diagram illustrating the electric configuration of the printer.

FIG. 4 is a diagram illustrating the waveform structure of an ejection driving pulse.

FIGS. 5A to 5D are sectional views illustrating the vicinity of a nozzle to explain movement of a meniscus when ink is ejected from the nozzle.

FIGS. 6A and 6B are schematic views illustrating a case where ink is ejected toward a print medium from respective nozzles of a nozzle row in the printer according to the invention.

FIGS. 7A and 7B are schematic views illustrating a case where ink is ejected toward a print medium from respective nozzles of a nozzle row in the printer according to a known example.

### DESCRIPTION OF EXEMPLARY EMBODIMENTS

Hereinafter, an embodiment of the invention will be described with reference to the accompanying drawings. Although the following embodiment is described as a preferred specific example of the invention in various forms, the scope of the invention is not limited to the forms as long as the description limiting the invention is clearly not mentioned. In the following description, an ink jet printing apparatus (hereinafter, referred to as a printer) will be described as an example of a liquid ejecting apparatus of the invention.

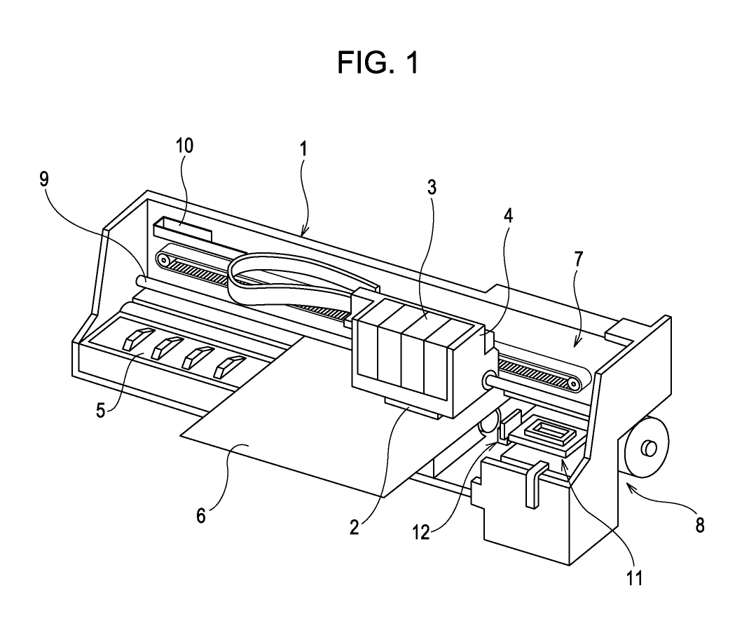

FIG. 1 is a perspective view illustrating the configuration of a printer 1. The printer 1 is mounted with a print head 2 as a liquid ejecting head and includes a carriage 4 detachably mounted with ink cartridges 3, a platen 5 disposed below the print head 2, a carriage moving mechanism 7 (which is a kind of movement unit) reciprocating the carriage 4 in a sheet surface direction of a print sheet 6 (which is a kind of landing target) as a printing medium, that is, a main scanning direction, and a sheet feeding mechanism 8 feeding the print sheet 6 in a sub-scanning direction perpendicular to the main scanning direction.

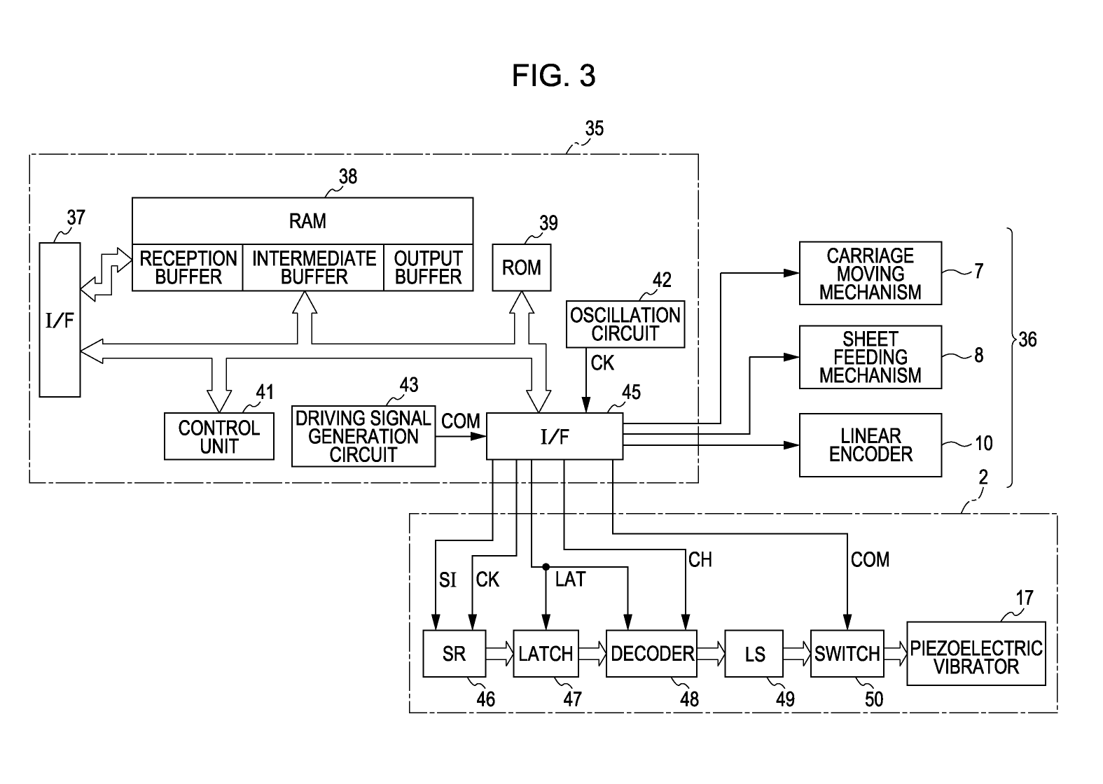

The carriage 4 is mounted on a guide rod 9 installed so as to be shaft-supported in the main scanning direction. Therefore, the carriage 4 is moved along the guide rod 9 in the main scanning direction by an operation of the carriage moving mechanism 7. The position of the carriage 4 in the main scanning direction is detected by a linear encoder 10. The detection signal, that is, an encoder pulse is transmitted to a control unit 41 (see FIG. 3) of a printer controller 35. With such a configuration, the control unit 41 can control a printing process (ejecting process) executed by the print head 2, while recognizing the scanning position of the carriage 4 (print head 2) on the basis of the encoder pulse from the linear encoder 10.

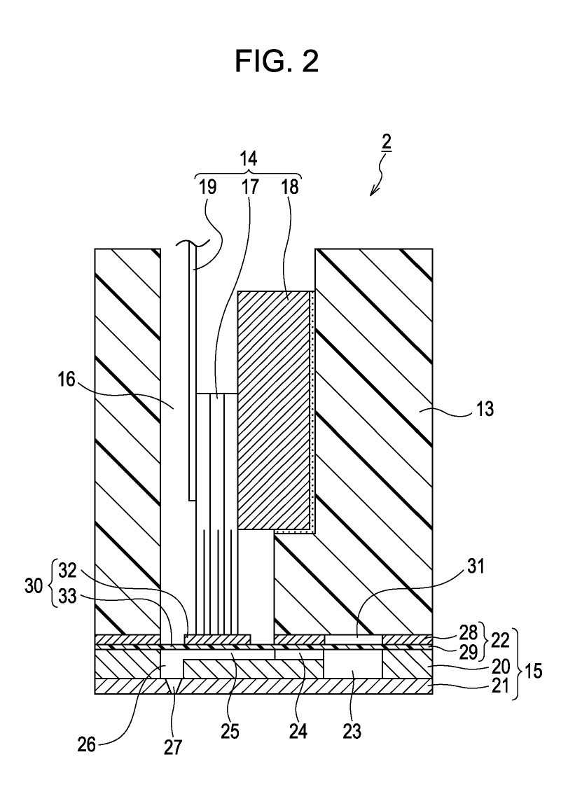

A home position serving as a base point of the scanning is set in an end region outside a print area within the movement range of the carriage 4. A capping member 11 sealing a nozzle formation surface (nozzle substrate 21: see FIG. 2) of the print head 2 and a wiper member 12 cleaning the nozzle formation surface are disposed at the home position according to this embodiment. The printer 1 is configured to be capable of executing so-called bi-directional printing of characters, an image, or the like on the print sheet 6 in both directions at forward movement time, at which the carriage 4 (print head 2) is moved toward the opposite end of the home position and at backward movement time, at which the carriage 4 is returned from the opposite end to the home position.

FIG. 2 is a sectional view illustrating the configuration of the main units of the print head 2. The print head 2 includes a case 13, a vibrator unit 14 received in the case 13, and a passage unit 15 joining to the bottom surface (front end surface) of the case 13. The case 13 is formed of, for example, epoxy-based resin. A receiving hollow portion 16 is formed in the case 13 to receive the vibrator unit 14. The vibrator unit 14 includes a piezoelectric vibrator 17 serving as a kind of pressure generation unit, a fixing plate 18 to which the piezoelectric vibrator 17 joins, and a flexible cable 19 supplying a driving signal or the like to the piezoelectric vibrator 17. The piezoelectric vibrator 17 is of a laminated type manufactured by separating a piezoelectric plate, which is formed by alternately laminating piezoelectric layers and electrode layers, in a pectinate form and is a vertical vibration mode piezoelectric vibrator expanded or contracted in a direction perpendicular to the lamination direction.

The passage unit 15 is formed by joining the nozzle substrate 21 to one surface of the passage substrate 20 and joining an elastic plate 22 on the other surface of the passage substrate 20. A reservoir 23, an ink supply port 24, a pressure chamber 25, a nozzle communication opening 26, and a nozzle 27 are formed in the passage unit 15. A series of ink passages from the ink supply port 24 to the nozzle 27 via the pressure chamber 25 and the nozzle communication opening 26 is formed to correspond to each nozzle 27.

The nozzle substrate 21 is a plate member formed of a metal plate made of stainless or a silicon single-crystal substrate, where a plurality of the nozzles 27 is punched in a row form at a pitch (for example, 180 dpi) corresponding to a dot formation density. In the nozzle substrate 21, a plurality of rows (nozzle groups) of the nozzles 27 is formed and 180 nozzles 27, for example, organize one nozzle row. The print head 2 according to this embodiment is configured to mount four ink cartridges 3 storing ink (which is a kind of liquid) of respective different colors, specifically, a total of four cyan (C) ink, magenta (M) ink, yellow (Y) ink, and black (K) ink. Therefore, a total of four nozzle rows are formed in the nozzle substrate 21 so as to correspond to these colors.

The elastic plate 22 has a double structure in which an elastic film 29 is laminated on the surface of a support plate 28. In this embodiment, the elastic plate 22 is manufactured using a composite plate member formed by forming a stainless plate, which is a kind of metal plate, as the support plate 28 and laminating a resin film as the elastic film 29 on the surface of the support plate 28. The elastic plate 22 is provided with a diaphragm portion 30 varying the volume of the pressure chamber 25. The elastic plate 22 is provided with a compliance portion 31 sealing a part of the reservoir 23.

The diaphragm portion 30 is manufactured by partially removing the support plate 28 by etching. That is, the diaphragm portion 30 includes an island portion 32 to which the front end surface of the piezoelectric vibrator 17 joins and a thin-walled elastic portion 33 surrounding the island portion 32. The compliance portion 31 is manufactured by removing the support plate 28 of a region facing an opening surface of the reservoir 23 by etching, as in the diaphragm portion 30. The compliance portion 31 functions as a damper absorbing a variation in the pressure of a liquid stored in the reservoir 23.

Since the front end surface of the piezoelectric vibrator 17 joins to the island portion 32, the volume of the pressure chamber 25 can be varied by expansion or contraction of the free end portion of the piezoelectric vibrator 17. With the variation in the volume, a variation in the pressure of the ink in the pressure chamber 25 is caused. The print head 2 ejects ink droplets from the nozzles 27 using the variation in the pressure.

FIG. 3 is a block diagram illustrating the electric configuration of the printer 1. The printer 1 includes the printer controller 35 and a print engine 36. The printer controller 35 includes an external interface (external I/F) 37 into which print data or the like is input from an external apparatus such as a host computer, a RAM 38 which stores a variety of data or the like, a ROM 39 which stores a control routine to process a variety of data, the control unit 41 which controls each unit, an oscillation circuit 42 which generates a clock signal, a driving signal generation circuit 43 (which is a kind of driving signal generation unit) which generates a driving signal to be supplied to the print head 2, and an internal interface (internal I/F) 45 which outputs pixel data obtainable by developing the print data into each dot and the driving signal to the print head 2.

The control unit 41 outputs a head control signal used to control the operation of the print head 2 to the print head 2 or outputs a controls signal used to generate a driving signal COM to the driving signal generation circuit 43. Examples of the head control signal include a transmission clock CLK, pixel data SI, a latch signal LAT, and a change signal CH1. The latch signal or the change signal defines supply timing of each pulse organizing the driving signal COM.

The control unit 41 executes a color conversion process of converting the RGB color system to the CMYK color system, a halftone process of reducing multiple gray-scale data up to a predetermined gray scale, and a dot pattern development process of arranging the data subjected to the halftone process in a predetermined arrangement form in each kind of ink (each nozzle row) and developing the data into dot pattern data to generate the pixel data SI used to control the ejection of the print head 2. The pixel data SI is data regarding pixels of an image to be printed and is a kind of ejection control information. Here, the pixels indicate a dot formation area imaginarily defined on a print medium such as a print sheet which is a landing target. The pixel data SI according to the invention is formed from gray scale data regarding whether dots formed on the print medium are formed (or whether ink is ejected) and regarding the size of the dot (amount of ink ejected). In this embodiment, the pixel data SI is organized by binary gray-scale data having a total of two bits. The 2-bit gray scale values each include [00] indicating non-printing (non-vibration) in which no ink is ejected, [01] indicating printing of a small dot, [10] indicating printing of a middle dot, and [11] indicating printing of a large dot. Accordingly, the printer according to this embodiment can execute printing in four gray scales.

Next, the configuration of the print engine 36 will be described. The print engine 36 includes the print head 2, the carriage moving mechanism 7, the sheet feeding mechanism 8, and the linear encoder 10. The print head 2 includes a plurality of shift registers (SR) 46, a plurality of latches 47, a plurality of decoders 48, a plurality of level shifters (LS) 49, a plurality of switches 50, and a plurality of piezoelectric vibrators 17 so as to correspond to the nozzles 27, respectively. The pixel data (SI) from the printer controller 35 is synchronized with the clock signal (CK) from the oscillation circuit 42 and is transmitted in series to the shift registers 46.

The latch 47 is electrically connected to the shift register 46. Therefore, when the latch signal (LAT) is input from the printer controller 35, the latch 47 latches the pixel data of the shift register 46. The pixel data latched by the latch 47 is input to the decoder 48. The decoder 48 translates the 2-bit pixel data and generates pulse selection data. The pulse selection data according to this embodiment is formed by data of a total of two bits.

The decoder 48 outputs the pulse selection data to the level shifter 49 when receiving the latch signal (LAT) or a channel signal (CH). In this case, the pulse selection data is input to the level shifter 49 in order from an upper bit. The level shifter 49 functions as a voltage amplifier. Therefore, when the pulse selection data is “1”, the level shifter 49 outputs a voltage enabling the drive of the switch 50, for example, an electric signal boosted to a voltage with about several tens of volts. The pulse selection data of “1” boosted by the level shifter 49 is supplied to the switch 50. The driving signal COM from the driving signal generation circuit 43 is supplied to the input side of the switch 50, and the piezoelectric vibrator 17 is connected to the output side of the switch 50.

The pulse selection data is used to control the operation of the switch 50, that is, the supply of an ejection pulse of the driving signal to the piezoelectric vibrator 17. For example, for a period in which the pulse selection data input to the switch 50 is “1”, the switch 50 is in a connection state, the corresponding ejection pulse is supplied to the piezoelectric vibrator 17, and the potential level of the piezoelectric vibrator 17 is varied in accordance with the waveform of the ejection pulse. On the other hand, in a period in which the pulse selection data is “0”, an electric signal enabling the operation of the switch 50 is not output from the level shifter 49. Therefore, since the switch 50 is in a disconnected state, no ejection pulse is supplied to the piezoelectric vibrator 17.

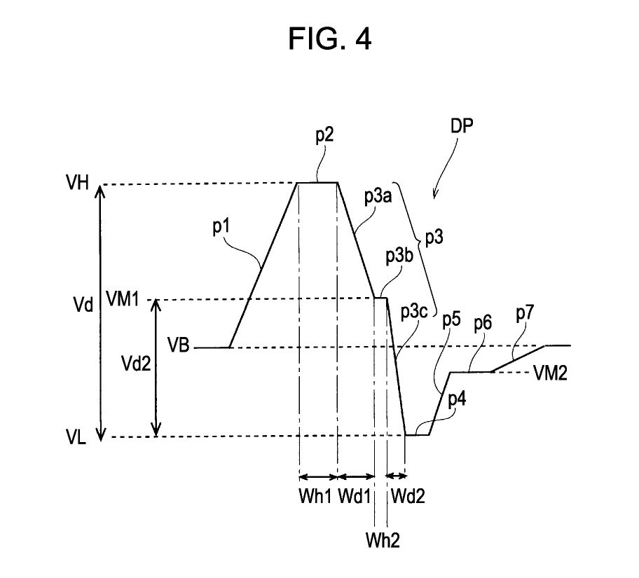

FIG. 4 is a diagram illustrating the waveform structure of an ejection driving pulse DP of the driving signal COM generated by the driving signal generation circuit 43.

As shown in FIG. 4, the ejection driving pulse DP includes a preliminary expansion section p1 (corresponding to a first variation section), an expansion hold section p2 (corresponding to a hold section), a contraction section p3 (corresponding to a second variation section), a contraction hold section p4, a vibration-suppression expansion section p5, a vibration-suppression hold section p6, and a return expansion section p7. The preliminary expansion section p1 is a waveform section in which a potential increases at a constant inclination in a plus direction (corresponding to a first direction) from a reference potential VB to an expansion potential VH. The expansion hold section p2 is a waveform section in which the expansion potential VH, which is the termination voltage of the preliminary expansion section p1, is constant. The contraction section p3 is a waveform section in which the potential decreases (drops) in a minus direction (corresponding to a second direction) from the expansion potential VH to a contraction potential VL. The contraction hold section p4 is a waveform section in which the contraction potential VL is constant. The vibration-suppression expansion section p5 is a waveform section in which the potential increases at a constant inclination in the plus direction from the contraction potential VL to a vibration-suppression expansion potential VM2. The vibration-suppression hold section p6 is a waveform section in which the vibration-suppression expansion potential VM2 holds. The return expansion section p7 is a waveform section in which the potential returns from the vibration-suppression expansion potential VM2 to the reference potential VB.

The contraction section p3 includes a first contraction component p3a (corresponding to a first variation component) in which the potential is varied (drops) in the minus direction from the expansion potential VH, an intermediate hold component p3b (corresponding to an intermediate hold component) in which an intermediate potential VM1, which is the termination potential of the first contraction component p3a, holds for a given time, and a second contraction component p3c (corresponding to a second variation component) in which the potential is varied (drops) in the minus direction from the intermediate potential VM1. That is, the contraction section p3 is configured such that the variation in the potential stops only in a short time while the potential is varied from the expansion potential VH to the contraction potential VL.

The intermediate potential VM1, which is the potential of the intermediate hold component p3b, is set to be in the range from 50% to 60% of the expansion potential VH, which is the potential of the expansion hold section p2. The potential inclination (a potential variation amount per about unit time) of the second contraction component p3c is set to be steeper than that of the first contraction component p3a. Specifically, the potential inclination of the second contraction component p3c is about twice the potential inclination of the first contraction component p3a. In addition, a time from the initial end to the termination end of the intermediate hold component p3b, that is, a hold time Wh2 is set to be in the range of expression (1) on the assumption that a vibration period of the pressure vibration occurring in the ink of the pressure chamber 25 is Tc.

0<Wh2≦0.12Tc (1)

In this expression, Tc is uniquely determined depending on the shape, size, and rigidity of each constituent member such as the nozzle 27, the pressure chamber 25, the ink supply port 24, and the piezoelectric vibrator 17. For example, the inherent vibration period Tc can be expressed as Expression (2).

Tc=2π√[((Mn×Ms)/(Mn+Ms))×Cc] (2)

In Expression (2), Mn denotes inertance in the nozzle 27, Ms denotes inertance in the ink supply port 24, Cc denotes the compliance (indicating a variation in the volume per about unit pressure and softness degree) of the pressure chamber 25. In Expression (2), the inertance M indicates that the liquid readily moves in the passage such as the nozzle 27. In other words, the inertance M is the mass of a liquid per unit cross-section area. On the assumption that the density of a liquid is ρ, the cross-section area of a surface perpendicular to a downflow direction of a liquid in a passage is S, and the length of the passage is L, the inertance M can be expressed as Expression (3).

M=(ρ×L)/S (3)

Tc may not be defined as in Expression (2), but may be the vibration period of the pressure chamber 25 of the print head 2.

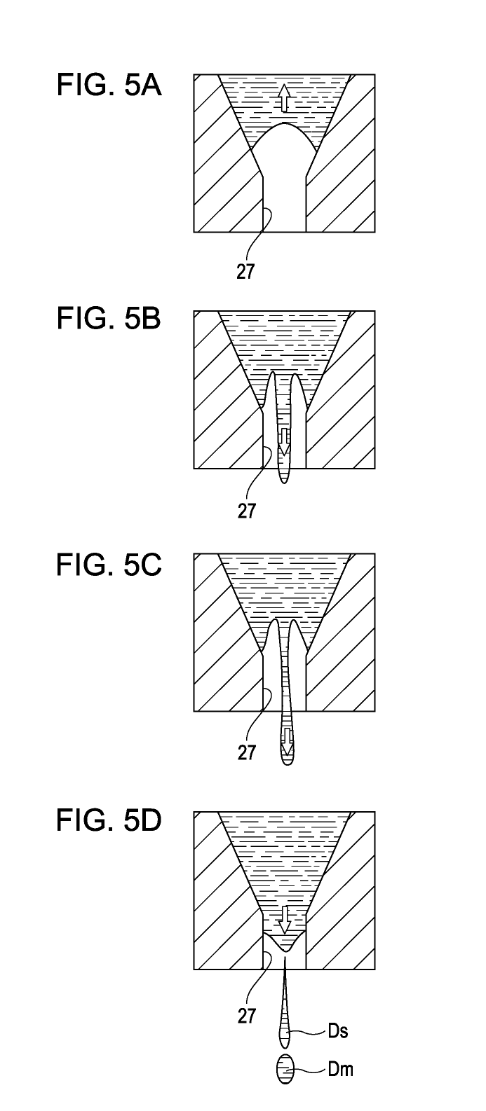

When the ejection driving pulse DP having the above-described structure is supplied to the piezoelectric vibrator 17, the piezoelectric vibrator 17 is first contracted in an element longitudinal direction by the preliminary expansion section p1, and thus the pressure chamber 25 is expanded from a reference volume corresponding to the reference potential VB to an expansion volume corresponding to the expansion potential VH (first variation step). As shown in FIG. 5A, the surface (meniscus) of the ink in the nozzle 27 is considerably drawn toward the pressure chamber 25 (an upper side of the drawing) by this expansion and the ink in the pressure chamber 25 is supplied from the reservoir 23 via the ink supply port 24. Then, the expansion state of the pressure chamber 25 holds for the entire supply period of the expansion hold section p2 (hold step).

After the expansion state by the expansion hold section p2 holds, the contraction section p3 is supplied and thus the piezoelectric vibrator 17 is expanded in response to the supply of the expansion section p3. Then, the pressure chamber 25 is contracted from the expansion volume to a contraction volume corresponding to the contraction potential VL (second variation step). Since the contraction section p3 includes the first contraction component p3a, the intermediate hold component p3b, and the second contraction component p3c, as described above, the pressure chamber 25 is contracted from the expansion volume to an intermediate volume corresponding to the intermediate potential VM1 by the first contraction component p3a by the second variation step (first variation action). In this way, the ink in the pressure chamber 25 is pressurized, as shown in FIG. 5B, the middle portion of the meniscus is extruded toward an ejection side (a lower side of the drawing) and thus the extruded portion grows in the form of a liquid column. Continuously, the intermediate hold component p3b is supplied, and then the intermediate volume is held only for the hold time Wh2 (hold action). Then, the expansion of the piezoelectric vibrator 17 temporarily stops. Meanwhile, as shown in FIG. 5C, the liquid column in the middle portion of the meniscus grows in the ejection direction by inertial force. However, since the ink in the pressure chamber 25 is not pressurized for a while, the liquid column is thus suppressed from growing.

After held by the intermediate hold component p3b, the piezoelectric vibrator 17 is expanded more rapidly by the second contraction component p3c than by the first contraction component p3a, and then the volume of the pressure chamber 25 is rapidly pressurized from the intermediate volume to the contraction volume (second variation action). In this way, as shown in FIG. 5D, the entire meniscus is extruded in the ejection direction and the rear end portion of the liquid column is accelerated. Then, the liquid column is separated from the meniscus, the separated portion is ejected as an ink droplet from the nozzle 27, and the separated portion flies. The ejected ink droplet is formed by a preceding main liquid droplet Dm and a subsequent satellite liquid droplet Ds separated from the main liquid droplet Dm. In this embodiment, since the rear portion of the liquid column, which is the satellite liquid droplet Ds, is accelerated by the second contraction component p3, the flying speed of satellite liquid droplet Ds is more rapid than that of the main liquid droplet Dm. In this way, the main liquid droplet Dm and the satellite liquid droplet Ds are integrated while the main liquid droplet Dm and the satellite liquid droplet Ds are ejected from the nozzles 27 and landed on a print surface of the print medium. Accordingly, a dot formed when the main liquid droplet Dm and the satellite liquid droplet Ds are landed on the print surface of the print medium comes to have a form close to a circle or an ellipse.

After the contraction section p3, the contraction state of the pressure chamber 25 holds for a given time by the contraction hold section p4. Meanwhile, the pressure of the ink in the pressure chamber 25, which is decreased by the ejection of the ink, is increased again by the inherent vibration. The vibration-suppression expansion section p5 is applied to the piezoelectric vibrator 17 at the time at which the pressure of the ink is increased, and thus the pressure chamber 25 is expanded from the contraction volume to the vibration-suppression expansion volume. Then, the pressure variation (residual vibration) of the ink in the pressure chamber 25 is reduced. The vibration-suppression expansion volume of the pressure chamber 25 is held for a given time by the vibration-suppression hold section p6. Thereafter, the pressure chamber 25 is expanded and the volume of the pressure chamber 25 is returned gradually to the normal volume by the return expansion section p7.

In this way, by stopping the variation in the volume of the pressure chamber 25 in a very short time while the volume of the pressure chamber 25 is varied from the expansion volume, which is the maximum volume, to the contraction volume, which is the minimum volume, sudden variation in the pressure of the pressure chamber 25 is suppressed compared to a case where the volume of the pressure chamber 25 is varied at once without stop between the expansion volume and the contraction volume. Therefore, when the ink is simultaneously ejected from the plurality of nozzles 27 adjacent to each other in the nozzle row, cross talk occurring between the adjacent nozzles is reduced. As a consequence, the difference between the flying speeds of the ink droplets ejected from the nozzles 27 is reduced, and thus the difference between landing positions of the ink droplets on the print medium can be prevented. Moreover, since these advantages can be achieved just by modifying the structure of the ejection driving pulse DP, the cross talk can be reduced simply without changing the configuration or size of the print head 2 or complicated control.

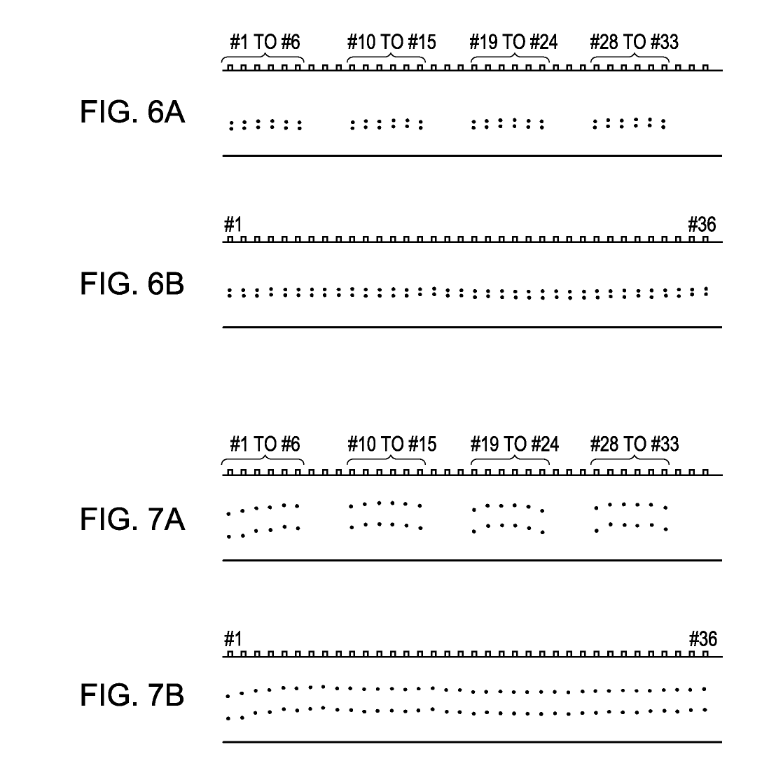

FIGS. 6A and 6B are diagrams illustrating a case where ink is ejected toward the print medium from the respective nozzles 27 of a nozzle row, when viewed a direction intersecting the flying direction of the ink. In the drawings, an upper straight line indicates a nozzle surface (surface of the nozzle substrate 21 on the ejection side) of the print head 2 and a lower straight line indicates a print surface of the print medium (print sheet 6). The nozzles 27 of #1 to #36 are illustrated among all of the nozzles 27 (for example, the nozzles 27 from #1 to #180) of the nozzle row. FIG. 6A shows a case where the ink is ejected from six adjacent nozzles 27 at an interval between three nozzles. More specifically, FIG. 6A shows the case (6 ON and 3 OFF) where the ink is ejected from the nozzles 27 of #1 to #6, #10 to #15, #19 to #24, and #28 to #33 among the nozzles 27 of #1 to #36 in the drawing, and the ink is not ejected from the nozzles 27 of #7 to #9, #16 to #18, #25 to #27, and #34 to #36. FIG. 6B shows a case where the ink is ejected from all of the nozzles 27 (the nozzles 27 of #1 to #36 in the drawing) of #1 to #180.

When the ink is ejected simultaneously from the plurality of adjacent nozzles 27 in the printer 1 according to the invention, the pressure vibration by which the adjacent nozzles affect each other is reduced. Therefore, the difference between the flying speeds of the ink droplets ejected from the respective nozzles 27 is suppressed. Accordingly, when the respective ink (the main liquid droplets and the satellite liquid droplets) ejected from the nozzle group of the ejection target is observed, as shown in FIGS. 6A and 6B, the ink flies in the form of one nearly horizontal line in the printer 1 according to the invention, compared to a case where the respective ink flies in a nearly arch form in a known example. Therefore, a dot group formed when the respective ink is landed on the print medium is also arranged in the form of a straight line in a plan view. Moreover, since a distance between the main droplet and the satellite liquid droplet can be reduced, the dot shape formed when these liquid droplets are landed on the print medium can be improved.

The invention is not limited to the above-described embodiment, but may be modified in various forms within the scope described in the appended claims.

The waveform structure of the ejection driving pulse DP is not limited to the structure exemplified in the embodiment. The ejection driving pulse may be a voltage waveform that includes at least: the first variation section in which the potential is varied in the first direction to vary the volume of the pressure chamber 25; the hold section in which the volume of the pressure chamber 25 varied by the first variation section holds for a given time and the termination potential of the first variation section is constant; and the second variation section in which the potential is varied in the second direction opposite to the first direction to vary the volume of the pressure chamber 25 varied by the first variation section.

In the above-described embodiment, the so-called vertical vibration mode piezoelectric vibrator 17 is used as a pressure generation unit. However, the invention is not limited thereto. For example, a bending vibration mode piezoelectric element may be used. In this case, the exemplified ejection driving pulse DP becomes a waveform reversed in the potential variation direction, that is, a waveform of which upper and lower portions are reversed.

The invention is not limited to a printer, but is applicable to any liquid ejecting apparatus capable of controlling ejection using a plurality of driving signals. Examples of the liquid ejecting apparatus include various kinds of ink jet printing apparatuses such as a plotter, a facsimile apparatus, and a copy apparatus, a display manufacturing apparatus, an electrode manufacturing apparatus, and a chip manufacturing apparatus. In the display manufacturing apparatus, liquids of various color materials of R (Red), G (Green), and B (Blue) are ejected from a color material ejecting head. In the electrode manufacturing apparatus, a liquid-like electrode material is ejected from an electrode material ejecting head. In the chip manufacturing apparatus, a bio-organism liquid is ejected form a bio-organism ejecting head.

What is claimed is:

1. A liquid ejecting apparatus comprising:
a liquid ejecting head which includes a nozzle ejecting a liquid, a pressure chamber communicating with the nozzle, and a pressure generation unit applying pressure variation to the liquid of the pressure chamber and which ejects the liquid from the nozzle by an operation of the pressure generation unit;
a driving signal generation unit which generates a driving signal containing an ejection driving pulse used to eject the liquid from the nozzle by driving the pressure generation unit; and
a movement unit which moves the liquid ejecting head relative to a landing target,
wherein a liquid droplet is ejected from the nozzle and is landed on the landing target, while the movement unit moves the liquid ejecting head relative to the landing target,
wherein the ejection driving pulse is a voltage waveform including:
a first variation section in which a potential is varied in a first direction to vary a volume of the pressure chamber;
a hold section in which the volume of the pressure chamber varied by the first variation section holds for a given time and a termination potential of the first variation section is constant; and
a second variation section in which the potential is varied in a second direction opposite to the first direction to vary the volume of the pressure chamber varied by the first variation section,
wherein the second variation section includes:
a first variation component in which the potential is varied in the second direction from the termination potential of the first variation section;
an intermediate hold component in which the termination potential of the first variation component holds for a given time; and
a second variation component in which the potential is varied in the second direction from the termination potential of the first variation component,
wherein the hold time of the intermediate hold component is greater than 0 and 0.12 Tc or less, and
wherein the potential of the intermediate hold component is in the range from 50% to 60% of the potential of the hold section.

2. A method of controlling a liquid ejecting apparatus including a liquid ejecting head which includes a nozzle ejecting a liquid, a pressure chamber communicating with the nozzle, and a pressure generation unit applying pressure variation to the liquid of the pressure chamber and which ejects the liquid from the nozzle by an operation of the pressure generation unit; a driving signal generation unit which generates a driving signal containing an ejection driving pulse used to eject the liquid from the nozzle by driving the pressure generation unit; and a movement unit which moves the liquid ejecting head relative to a landing target, the liquid ejecting apparatus ejecting a liquid droplet from the nozzle and landing the liquid droplet on the landing target, while the movement unit moves the liquid ejecting head relative to the landing target,
wherein the ejection driving pulse is a voltage waveform including a first variation section in which a potential is varied in a first direction, a hold section in which a termination potential of the first variation section is constant, and a second variation section in which the potential is varied in a second direction opposite to the first direction,
wherein the second variation section includes a first variation component in which the potential is varied in the second direction from the termination potential to a halfway potential of the first variation section, an intermediate hold component in which the termination potential of the first variation component holds for a given time, and a second variation component in which the potential is varied in the second direction from the termination potential of the first variation component,
wherein the potential of the intermediate hold component is in the range from 50% to 60% of the potential of the hold section,
wherein the hold time of the intermediate hold component is greater than 0 and 0.12 Tc or less,
wherein the method comprises:
a first variation step of varying the volume of the pressure chamber by the first variation section;
a hold step of holding the volume of the pressure chamber varied in the first variation step for a predetermined time by the hold section;
a second variation step of varying the volume of the pressure chamber varied in the first variation step by the second variation section,
wherein the second variation step includes:
a first variation action of varying the volume of the pressure chamber varied in the first variation step to a halfway volume by the first variation component;
a hold action of holding the volume of the pressure chamber varied by the first variation action for a given time; and
a second variation action of varying the volume of the pressure chamber holding in the hold action by the second variation component, and
wherein the hold time in the hold action is greater than 0 and 0.12 Tc or less.
